(19) United States
(12) Patent Application Publication
(10) Pub. No.: US 2009/0194910 A1
(43) Pub. Date: Aug. 6, 2009

(54) Two Stage Spring Pack Device for Hot Runner Sealing

(75) Inventors: Raymond Rosner, Winooski, VT (US); Darrin Albert MacLeod, Jeffersonville, VT (US); Abdeslam Bouti, Swanton, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 12/023,915

(22) Filed: Jan. 31, 2008

(51) Int. Cl. B29C 45/20

(52) U.S. Cl. 264/328.15; 425/549

(57) ABSTRACT

A two stage spring pack device comprising a nozzle or back up insulator, surrounded by a first stage spring for applying an initial force, and a plurality of Belleville springs to exert a secondary force against a thermally expanding hot runner manifold in an injection molding system, precludes resin leakage between a manifold and nozzle or between mating manifolds in a cross manifold system. The first stage spring imparts a relatively low initial force against the hot runner components while the system heats up from ambient temperature to prevent plate bowing and component hobbing, until it is fully compressed, at which point a subsequently larger sealing force is exerted by the constant force Belleville springs to prevent leakage between the mating components at operating temperature and injection pressure.

### TECHNICAL FIELD OF THE INVENTION

The present invention relates to, but is not limited to, an injection molding system, and more specifically the invention relates to a dual stage spring arrangement whereby a lower spring force is applied to the hot runner assembly at ambient temperature and during heat up and a relatively higher spring force results from the thermal expansion of the near fully heated components when the hot runner approaches and reaches operating temperature, in order to achieve sufficient sealing force there between.

It is well know to those skilled in the art of injection molding that the basic structure of a hot runner includes at least one heated, steel manifold through which a plurality of melt channels conveys molten resin from the sprue inlet to at least one manifold melt channel exit. The manifold or manifolds are stationed between a manifold plate and a backing plate, both being of which are steel with cooling lines therethrough, with an insulating air gap surrounding said manifolds with the exception of some contact points. In the case of a single manifold, installed intimately against the manifold at each manifold melt channel exit, is at least one nozzle such that the nozzle melt channel is in fluid communication with the manifold melt channel exit to allow the molten resin to flow to and fill a mold cavity located between a mold cavity plate and mold core plate, thereby defining a mold cavity to create a molded article when fed molten resin. Conversely, on the sprue inlet side of a single manifold, at least one insulator, made of high strength, low thermally conductive material, insulator is positioned opposite the nozzle to secure the manifold and nozzle in place between the manifold plate and the backing plate while at the same time minimizing thermal conduction of heat from the manifold to the cooled backing plate. In the case of a multi-manifold system, a cross manifold may be positioned atop a plurality of main manifolds, whereby each manifold melt channel exit of the cross manifold mates with, and is in fluid communication with, a corresponding inlet melt channel on each main manifold.

Due to the fact that the manifolds are heated, via manifold heaters usually embedded in the surface of the manifold, and the surrounding manifold plate is cooled in use via cooling lines, there exists a dynamic differential in melt channel alignment when the system is brought from room temperature to its heated operating state. In non-use conditions, otherwise known as room, or ambient, temperature, manifolds are sized such that the manifold melt channel exit is not fully aligned with the melt channel of the nozzle or, in the case of a multi-manifold system, the cross manifold melt channel exit is not fully aligned with the main manifold inlet melt channel. Conversely, the nozzle is positioned in the manifold plate such that its internal melt channel is in near perfect alignment along its axial centerline through to the mold cavity centerline and since it resides in the cooled manifold plate, remains in alignment throughout the molding process. Each manifold, however, begins in a contracted state such that when heated from room temperature, the radial, thermal expansion of the steel manifold from its centrally secured mounting point brings the manifold melt channel exit into alignment with the stationary nozzle melt channel or main manifold inlet melt channel.

In addition to the abovementioned radial, thermal expansion the manifold experiences during the heating cycle, the manifold also expands thermally across its thickness. Since the manifold is positioned either between the nozzle in the manifold plate, or another manifold, and a backup insulator against the backing plate, as it heats up, it must be free enough to slide between the two components while also expanding in thickness, thus eliminating any gap there between, or even interfering with, the mating components.

One method of ensuring proper alignment and sufficient seal off force between the nozzle or mating manifold melt channel interfaces, while at the same time allowing thermal movement between the steel to steel contacting surfaces of the hot runner components, is to install at least one spring, typically a Belleville spring, mounted under the nozzle, or backup insulator, such that it urges the two mating surfaces and corresponding melt channels tightly together in an effort to prevent resin leakage from the melt channel interface during the heat up stage and while operating. It must be noted however, that while this method of seal off retention is effective, spring force varies linearly with the amount of deflection applied to the spring. That is, the more the spring is compressed, the greater the force applied by the spring. This results in a high spring rate for the initial deflection of constant force springs.

The current technology of Belleville springs with their high spring rate (force/deflection) contributes to many of the hot runner problems we face today, namely bowing manifold and backing plates, nozzle tipping, galling between moving components, and high preloads, which can all contribute ultimately to resin leakage within the hot runner. These problems result from trying to achieve two effects from one spring; low preload to seal the melt channels as the system heats up to operating temperature, and a large final force to seal the stack up of components during the molding process. Additionally, in order to achieve and control the final preload delivered by the spring, tightly toleranced dimensions for both the nozzle and/or backup insulator components and installations must be machined resulting in increased manufacturing costs.

U.S. Pat. No. 6,368,542 B1 and U.S. Pat. No. 6,649,112 B2 to Steil et al describes a thermal expansion compensation support which applies a first force level provided primarily by a spring and a second force level provided by metal-to-metal contact between the hot runner components. This approach relies on one constant force Belleville spring, or spring set, to apply a load to the manifold throughout the entire heating cycle, concluding with a solid, metallic connection within the support occurring just before the ultimate operating temperature of the system is reached and maintained. As outlined above, because the single Belleville spring set must deliver sufficient force throughout a large temperature range, from ambient to resin processing temperature, the result is excessive force on the entire assembly before the maximum seal off is required between mating melt channels during processing, causing plate bowing and undesirable component loading. Additionally, the secondary phase of metal-to-metal contact within the support precludes any further flexibility of the support to deliver additional seal off pressure should the hot runner be operated outside its predicted range which may result in hobbing or permanent deformation of the support, the manifold or the surrounding clamp plate, thus rendering the system vulnerable to resin leakage upon its next start up.

U.S. Pat. No. 6,561,790 to Blais et al, further describes a plurality of Belleville springs used to impart a preload through a cross manifold to a mating main manifold to prevent inter-manifold leakage. Because the relative projected area of the melt channel diameter between manifolds is larger than those between a main manifold and nozzle, for instance, a much larger force must be exerted at the intersection of manifold melt channels to prevent their separation during molding under typical injection pressures. This necessitates a stack up of Belleville springs to achieve the necessary spring force which can have adverse affects including backing plate hobbing and bowing as well as potential failure of the Belleville springs should thermal expansion of the multiple manifolds exceed the range of flexure of the springs.

The present invention is directed to overcoming one or more of the problems or disadvantages set forth above, and for providing a mechanism or process consisting of a group of components to act as one single loading device or step which has two different spring rates.

### SUMMARY

The present invention is directed to a device which will supply a relatively small initial force until it reaches the designed deflection where it then applies a large constant force over a large deflection range. Compared to the abovementioned existing spring designs this device will reduce plate bowing, nozzle tipping, galling, and high preloads which can all lead to potential resin leakage within the hot runner. The present invention is directed to a two stage hot runner spring pack comprising: at least one spring which acts in series with the entire assembly but which is not preloaded; a mechanical fastener which holds the constant force Belleville springs to their preload point, and which allows for further deflection; and a plurality of constant force Belleville springs which are preloaded to the point in their spring curve where the force is relatively constant for variances in deflection, and which addresses the two problems by attacking them individually; one spring for preload, and a stack of springs to generate the sealing loads required during molding.

In one embodiment, the present invention is directed to a two stage spring pack positioned concentrically under a nozzle flange while installed in a spring bore in a manifold plate, its axis aligned with that of the nozzle as well as a central melt channel located therein, the melt channel being in fluid communication with the manifold melt channel.

In another embodiment, the present invention is directed to a two stage spring pack installed adjacent to a cross manifold in axial alignment with a melt channel system which traverses an interface between said cross manifold and a main manifold, the melt channels being in fluid communication with one another. In this embodiment, the spring pack is installed adjacent to a cross manifold and within a bore in a backing plate, while a center insulator is located below a main manifold, such that all components and melt channels are in axial alignment cooperatively.

These and other features, aspects, and advantages of the present invention will become better understood with regard to the following description, appended claims and accompanying drawings.

### BRIEF DESCRIPTION OF THE DRAWINGS

FIG. 1 is a section view assembly of the two stage spring pack in accordance with the present invention, showing both the first stage spring and the Belleville springs under a nozzle flange in an initial, relaxed state before final assembly.

FIG. 2 is a section view assembly of the two stage spring pack in accordance with the present invention, showing both spring arrangements in a cold, assembled condition with a manifold and with Belleville springs being initially preloaded.

FIG. 3 is a section view assembly of the two stage spring pack in accordance with the present invention, showing the system in a partially heated state, such that the first stage spring is fully compressed by thermal expansion of the manifold.

FIG. 4 is a section view assembly of the two stage spring pack in accordance with the present invention, showing the system in a fully heated, operational state, such that the first stage spring is fully compressed and the Belleville springs are also compressed beyond their initial preloaded state.

FIG. 5 is a section view assembly of the two stage spring pack in accordance with another embodiment of the present invention, whereby a back up insulator replaces the nozzle and is shown in an initial, relaxed state before assembly with a cross manifold.

FIG. 6A is a graph illustrating the Force-Deflection curve of a typical Belleville spring assembly back up insulator used to seal a cross manifold to a main manifold.

FIG. 6B is an isometric illustration of the Belleville spring assembly back up insulator related to the graph shown in FIG. 6A.

FIG. 6C is a section view of the Belleville spring assembly shown in FIG. 6B.

FIG. 7A is a plan view of a typical Belleville spring.

FIG. 7B is a cross section view of the Belleville spring of FIG. 7A illustrating its frustoconical geometry.

FIG. 7C illustrates how a combination of orientations of Belleville springs may be stacked.

FIG. 8 is a comparative graph depicting a two stage spring pack Displacement vs. Load curve.

FIG. 9 is a section view detail of a portion of the hot runner, in accordance with one embodiment of the present invention, including a two stage spring pack as it is installed to support a cross manifold and main manifold.

### DETAILED DESCRIPTION

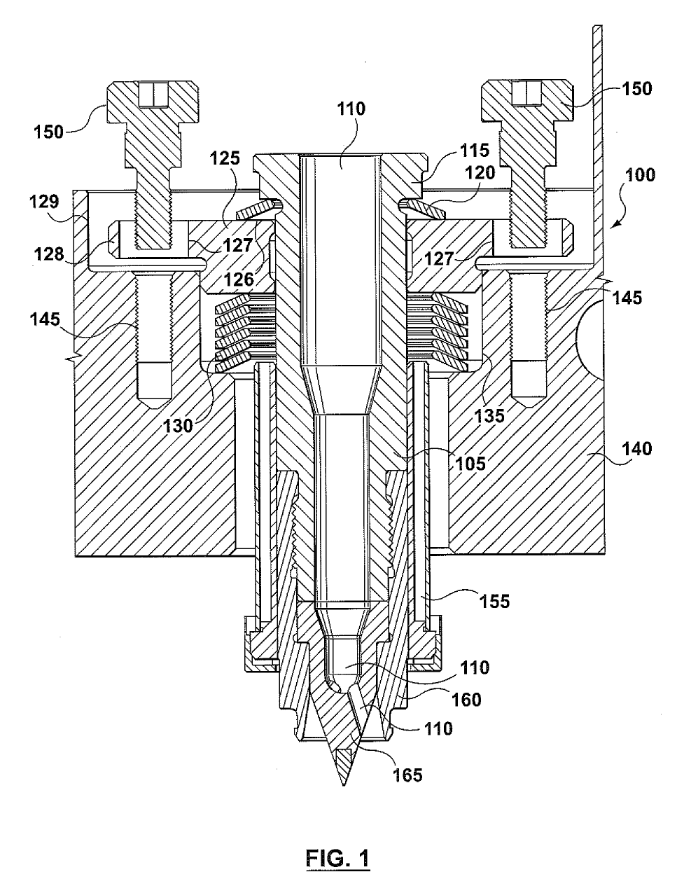

Referring now to FIG. 1, to one embodiment of the present invention is illustrated, a two stage spring pack 100 and its associated components are detailed. Central to the assembly is a nozzle 105, with a nozzle melt channel 110 contained axially therein, also having a nozzle flange 115 at one end, directly under which is located a first stage spring 120, though a plurality of first stage springs 120 may also be utilized. A spring retainer 125, which resides within a spring retainer bore 129, is collocated below the first stage spring 120 and adjacent to a plurality of Belleville springs 130, the primary purpose of the spring retainer 125 being to preload the Belleville springs 130 within a spring bore 135 in a manifold plate 140. The manifold plate 140 is also equipped with a plurality of tapped holes 145 into which an equivalent amount of a plurality of threaded fasteners 150 install to affix the spring retainer 125, through a plurality of counterbores 127 in a spring retainer flange 128, to the manifold plate 140. The secondary purpose of the spring retainer 125, which shall be illustrated in subsequent figures, is to provide a bearing surface 126 for the first stage spring 120 to transmit load from the nozzle flange 115 there through to the Belleville springs 130 during heat up of the system. The nozzle 105 is heated via a nozzle heater 155 which serves to conduct heat through a nozzle tip retainer 160 to a nozzle tip 165, in this illustration, all in effort to maintain a near constant temperature of resin flowing in the nozzle melt channel 110.

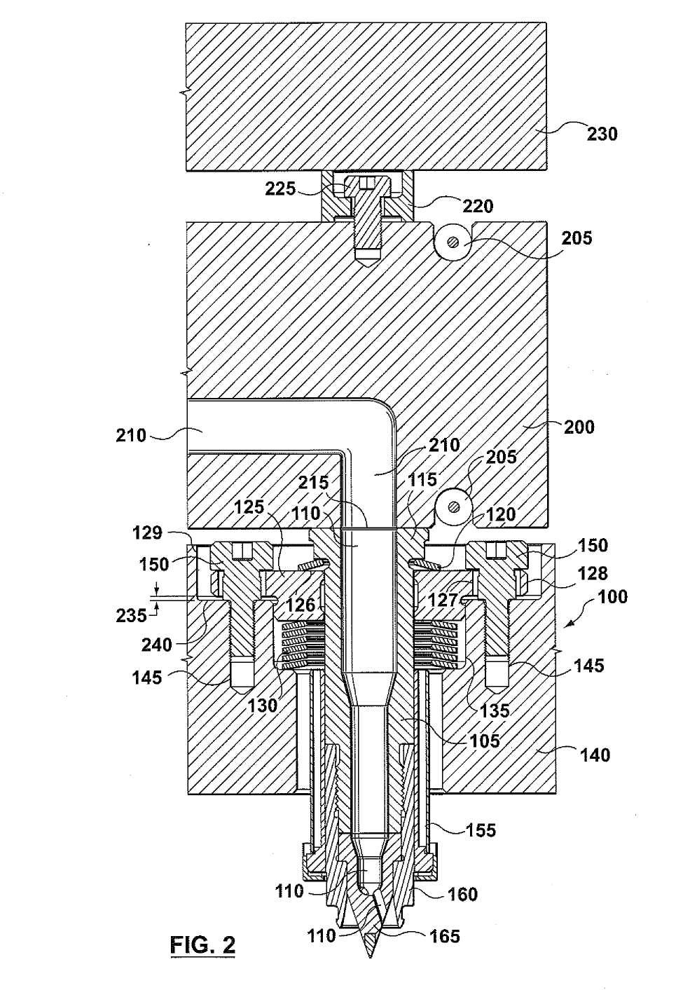

FIG. 2 illustrates the interaction of the two stage spring pack 100 with the rest of the adjacent hot runner components, namely a manifold 200, which is heated via a plurality of manifold heaters 205, typically embedded or integral within said manifold 200, their primary purpose being to maintain near constant temperature of resin flowing within a plurality of manifold melt channels 210. Located distally from a melt channel interface 215 between a manifold melt channel 210 and the nozzle melt channel 110 is an insulator 220, typically secured to the manifold 200 by a socket head cap screw 225, which abuts a backing plate 230. The insulator 220 is positioned axially in line with the melt channel interface 215 to support the spring load as afforded by the first stage spring 120 and the Belleville springs 130 in effort to seal off and prevent leakage of molten resin at the melt channel interface 215.

Referring still to FIG. 2, as the manifold 200 heats up from ambient temperature, its radial thermal expansion causes it to translate the melt channel interface 215 across the nozzle flange 115 from a position slightly short of aligned to one of near precise alignment of centers of the manifold melt channel 210 to the nozzle melt channel 110 in preparation for injection molding. Additionally, during heat up, the manifold 200 expands thermally across its thickness, thereby taking up increasing space and exerting escalating force between mating components such as the nozzle flange 115 and the insulator 220. During this sequence, it is the first stage spring 120 which provides sufficient pressure to the nozzle flange 115 to seal off the melt channel interface 215 to preclude leakage at this point as the resin comes up to processing temperature. At this stage, a gap 235 exists between the spring retainer flange 128 and the bottom of the spring retainer bore 129, as maintained by the preload of the Belleville springs 130.

The first stage spring 120 is designed specifically so as not to exert excessive force thereby allowing the manifold 200 to slide freely over the nozzle flange 115 during its thermal expansion and not bind up possibly causing the nozzle 105 to tip, thus creating a leak point. Also, the reduced force of the first stage spring 120 alleviates potential hobbing of the insulator 220 into the backing plate 230, or permanent compressive deformation of the insulator 220, both instances leading to future leakage of the hot runner due to insufficient preload in this area. Additionally, a reduced spring force between components during this stage of heat up prevents the manifold plate 140 or the backing plate 230 or both from bowing out due to excessive internal forces, thereby precluding damage to the hot runner and mold.

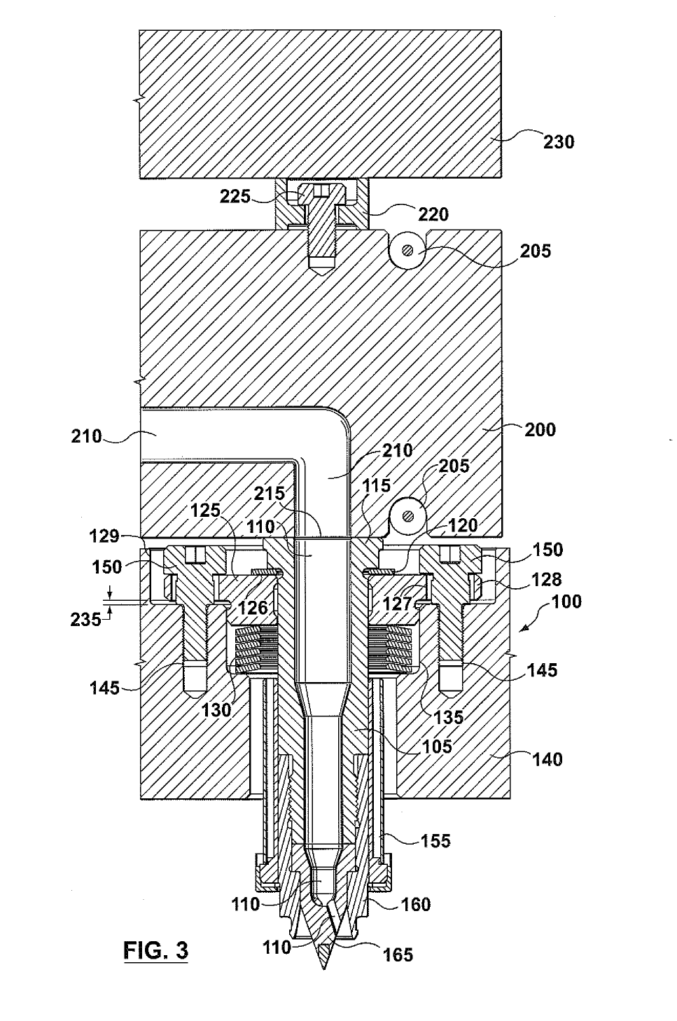

Turning now to FIG. 3, while the spring retainer 125 continues to secure the Belleville springs 130 in their preloaded state, sustained thermal expansion of the manifold 200 exerts increased force upon the first stage spring 120 via the nozzle Flange 115, to the point at which the first stage spring becomes totally compressed to a flat profile. The gap 235 between the spring retainer 125 and the bottom of the spring retainer bore 129 is maintained at this point due to the continued preload of the Belleville springs 130.

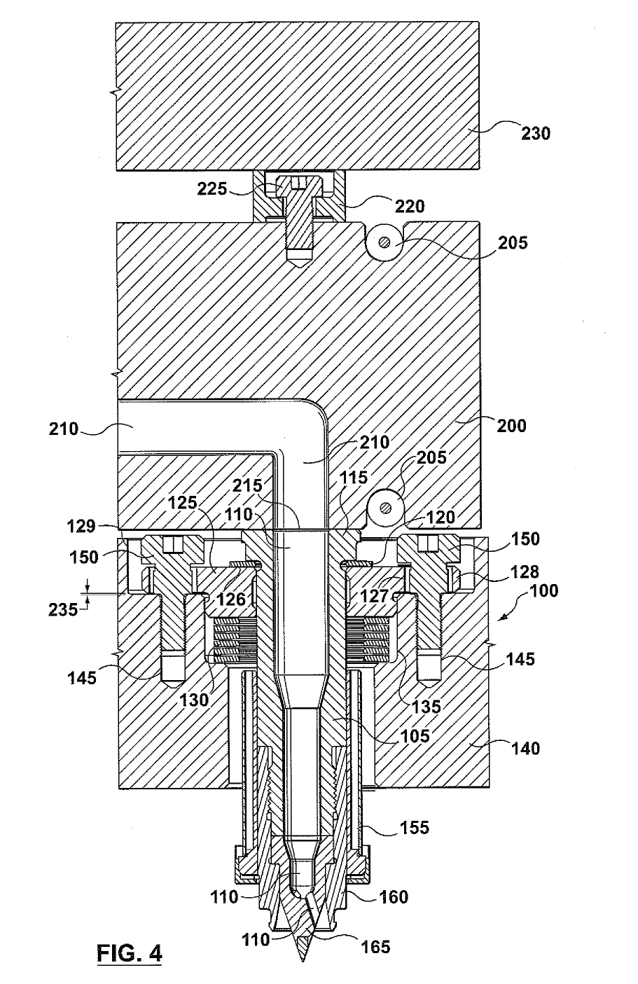

FIG. 4 completes the series of illustrations showing the embodiment of the present invention in which the nozzle 105 is impacted by thermal expansion of the manifold 200. In this view, the components are shown at their desired resin processing temperature and the manifold 200 has completed its heat up and is at equilibrium. The increased, final thickness of the manifold 200 causes the nozzle flange 115 to act upon the spring retainer 125 through the first stage spring 120, which is flattened, to further compress the plurality of Belleville springs 130. The spring retainer 125 may travel and compress the Belleville springs to a point at which the gap 235 is reduced to zero, at which point the spring retainer 125 can move no further so as to prevent over deflection of the Belleville springs and their failure, by design. Because the Belleville springs 130 were previously preloaded within the spring bore 135, the force now exerted back to the melt channel interface 215 is instantaneously greater than the initial preload and will bear a relatively flat spring force back upon the nozzle flange 115.

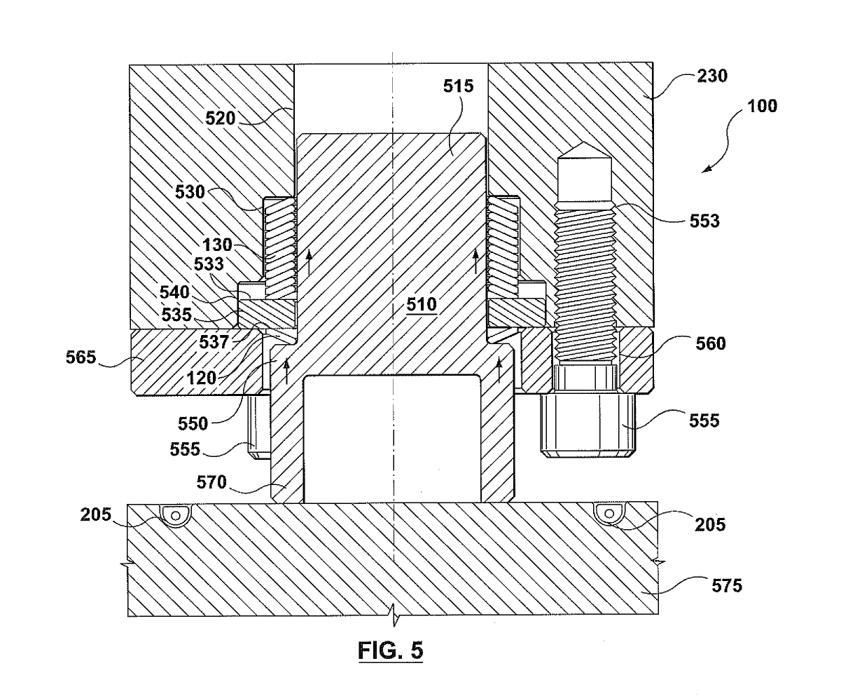

Referring now to FIG. 5 and another embodiment of the present invention, a two stage spring pack 100 is detailed as it is used to support a cross manifold 575, and resides in a backing plate 230. A back up insulator 510 is central to the two stage spring pack 100 and is oriented such that a back up insulator shaft 515 inserts into a back up insulator bore 520 within the backing plate 230 and is free to reciprocate there through. Surrounding the back up insulator shaft 515 is a plurality of Belleville springs 130 which, because of their frustoconical or cup shape, are stacked together in similar orientation to optimize space while simultaneously increasing load force. The Belleville springs 130, centered on the back up insulator shaft 515, are contained within a spring bore 530 which is concentric to the back up insulator bore 520. Holding the Belleville springs 130 in a compressed or preloaded state within the spring bore 530 is a stack face 533 of a spring retainer 535, the spring retainer 535 being of larger overall diameter than the Belleville springs 130 thus requiring a spring retainer recess 540 in the backing plate 230 in which to reside.

Also encircling the back up insulator shaft 515 is at least one first stage spring 120 which is located directly beneath the back up insulator flange 550, and adjacent to a single face 537 of the spring retainer 535. The purpose of the first stage spring 120 is to apply an initial preload force to the cross manifold 575 during its heat up phase, as provided by a plurality of manifold heaters 205. The backing plate 230 has a plurality of tapped holes 553 to accept a plurality of fasteners 555 which pass through a corresponding plurality of counterbores 560 machined through a cover plate 565.

In use, a back up insulator head 570 of the back up insulator 510 is abutted against the cross manifold 575 and serves to align and support said cross manifold 575 during its heat up stage when thermal expansion takes place. Additionally, and because of the intimate contact between the cross manifold 575 and the back up insulator head 570, the thermal expansion across the width of the cross manifold 575, forces the back up insulator 510 towards the backing plate 230. As described previously, the back up insulator shaft 515 is free to travel deeper into the back up insulator bore 520 of the backing plate 230 while the back up insulator flange 550 begins to compress the first stage spring 120 against the spring retainer 535.

Similar to the mechanisms of the two stage spring pack 100 described above as implemented under the nozzle flange 115, when thermal expansion of the cross manifold 575 in FIG. 5 forces the back up insulator 510 and hence, the back up insulator flange 550, to fully compress the first stage spring 120, the second stage of spring compression occurs whereby the back up insulator flange 550, acting through the first stage spring 120, which has been flattened, via the spring retainer 535, continues on to compress the Belleville springs 130, which have already been preloaded in the spring bore 530. Again, this preloaded state of the Belleville springs 130 ensures that the secondary force imparted to the back up insulator 510, and essentially, the cross manifold 575 is sufficiently high to provide seal off protection

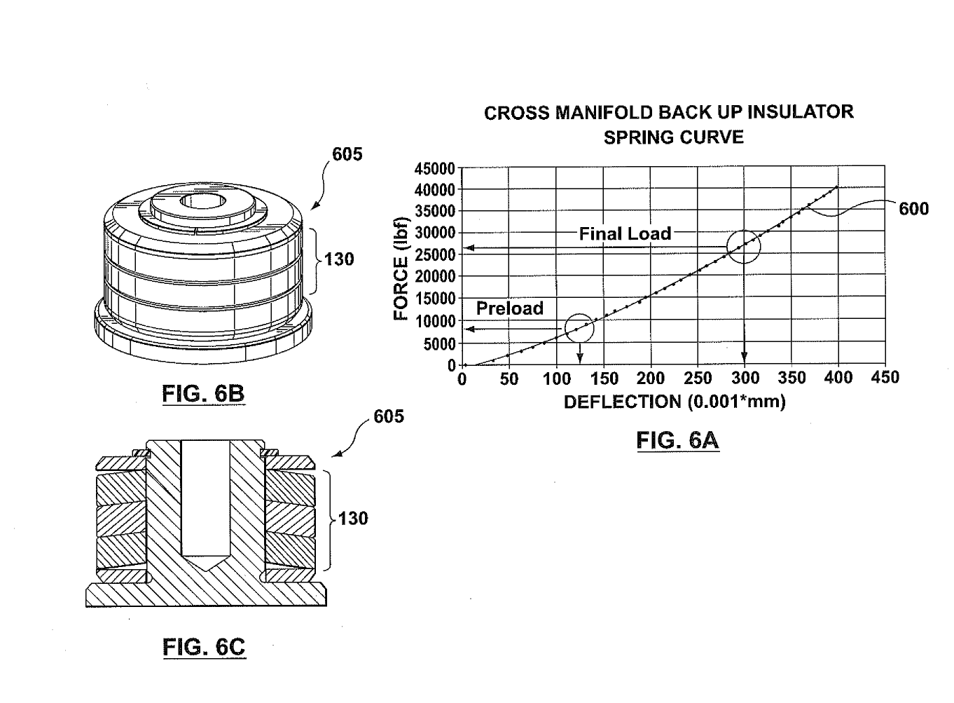

Referring now to FIG. 6A, a graph illustrating a typical Force versus Deflection curve 600 for a cross manifold back up insulator 605 shown in FIG. 6B which relies solely on a plurality of Belleville springs 130 to apply a preload to a manifold (not shown). FIG. 6C sections the back up insulator of FIG. 6B to illustrate the nested stacking method of the frustoconically shaped Belleville springs; a design to build up combined spring force within limited space. Since the spring force varies with the deflection of the springs, as illustrated by the steepness of the Force versus Deflection curve 600, to achieve the desired spring load at operating condition, the initial preload must be very high. These extreme conditions tend to lead to galling, tipping and bowing of the hot runner components culminating in resin leakage within the system.

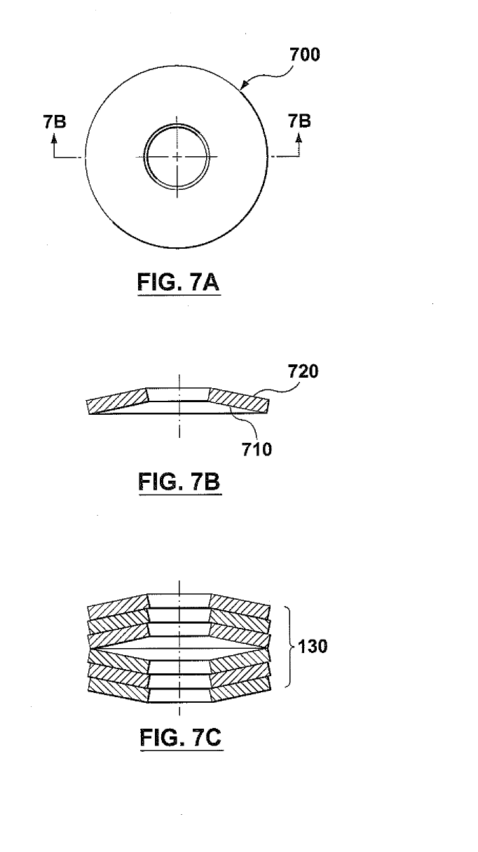

The plan and section views of a single Belleville spring 700 have been isolated in FIGS. 7A and 7B to better illustrate how its geometry, namely its overall frustoconical shape lends well to stacking a plurality of Belleville springs 130, as shown in FIG. 7C as well as in FIGS. 6B and 6C. In FIG. 7B, both a concave surface 710 and a convex surface 720 are highlighted to indicate that a definite orientation option exists when stacking a plurality of Belleville springs 130 and that they may be stacked in either series or parallel configurations or combinations thereof as FIG. 7C illustrates.

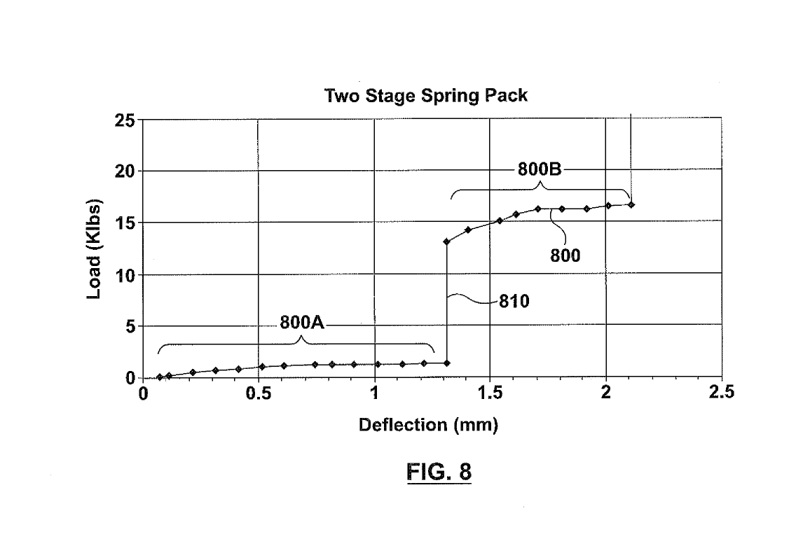

Turning now to FIG. 8, a second graph, this time of the Displacement versus Load curve 800 of the present invention in both loading scenarios. Pertinent to the Displacement versus Load curve 800 is a low preload zone 800A and a high seal force zone 800B illustrating the dual or stepped spring rates of the present invention. In summary, and with reference to FIG. 2, in operation, the manifold 200 to be loaded is in contact with the two stage spring pack 100 and deflects the first stage spring 120 with an initial amount to apply a preload. As the manifold 200 thermally expands, or moves in the direction of the two stage spring pack 100, it causes even greater deflection of the first stage spring 120. The spring force will only be as high as the low preload zone 800A of the first stage spring 120, a range of zero to about 1,000 pounds force, until said first stage spring 120 flattens. Once the first stage spring 120 is fully compressed, the expansion of the manifold 200 will begin to deflect the plurality of Belleville springs 130 which have constant force characteristics, as illustrated by a transition curve 810. The plurality of Belleville springs 130 is already preloaded such that spring force exerted in the high seal force zone 800B will be much greater than that of the first stage spring 120, a range of about 12,000 to 17,000 pounds force. The Belleville springs 130 will also exert a relatively flat spring curve, as illustrated by the high seal force zone 800B, due to their designed geometry.

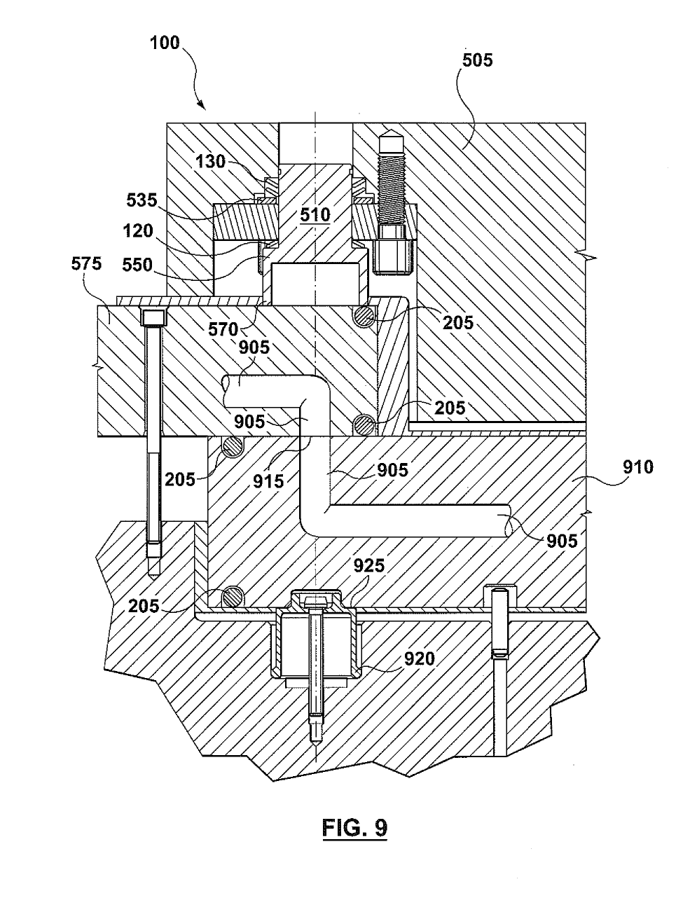

Referring now to FIG. 9, the detailed embodiment of the present invention shown in FIG. 5 is included in an application whereby the two stage spring pack 100 is implemented to provide a sealing force between a cross manifold 575 and a main manifold 910, supported distally by a center insulator 920, such that resin flowing in a melt channel 905 from the cross manifold 575 traverses a manifold melt channel interface 915 between the cross manifold 575 and the main manifold 910 and enters the melt channel 905 in the main manifold 910 without leaking at said manifold melt channel interface 915. At initial assembly of the system at ambient temperature, the first stage spring 120 may be compressed slightly to ensure the internal hot runner components are secure and aligned sufficiently before heat up. Once heating of the system is begun, the cross manifold 575 and the main manifold 910 will thermally expand both axially and in thickness thereby aligning the melt channel 905 in the cross manifold with the melt channel 905 in the main manifold, as well as acting upon the back up insulator 510. Since the main manifold 910 is in contact with a supporting surface 925 of the center insulator 920, which is a solid member, its thermal expansion is directed toward the cross manifold 575. Additionally, the thermal expansion of the cross manifold 575 forces the back up insulator head 570 to move toward the backing plate 230 thereby compressing the first stage spring 120 which, in turn, acts to return a force to said cross manifold 575. This reaction force urges the cross manifold 575 and the main manifold 910 together sufficiently to preclude molten resin leakage at the manifold melt channel interface 915.

While still referring to FIG. 9, but also with reference to FIG. 5, this application of the present invention is maintained with further compression of the first stage spring 120 due to the thermal expansion of both the cross manifold 575 and the main manifold 910 during the heat up process. Eventually, the first stage spring is compressed completely and the back up insulator flange 550 continues to translate the movement via the first stage spring 120 through the spring retainer 535 to the Belleville springs 130. The Belleville springs 130, which are already slightly preloaded by the spring retainer 535 return a significantly higher force than the first stage spring 120 which acts to ensure sufficient seal off at the manifold melt channel interface 915 during operation of the hot runner at processing temperatures and pressures.

Description of the embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention.

Having thus described the embodiments of the present invention, it will be apparent that modifications and enhancements are possible without departing from the concepts as described. Therefore, what is to be protected by way of letters patent are limited by the scope of the following claims:

What is claimed is:

1. A two stage spring pack for use in a hot runner in an injection molding system, comprising:
a nozzle proximate which the two stage spring pack is installed;
a first stage spring for applying an initial force; and
a plurality of Belleville springs to exert a secondary force.

2. The two stage spring pack according to claim 1, wherein a plurality of first stage springs is included.

3. The two stage spring pack according to claim 1 wherein a spring retainer preloads the Belleville springs.

4. The two stage spring pack according to claim 1, wherein the first stage spring exerts a load in a range of zero to about 1,000 pounds force.

5. The two stage spring pack according to claim 1, wherein the Belleville springs exert a load in a range of about 12,000 to 17,000 pounds force.

6. The two stage spring pack according to claim 1, wherein the Belleville springs are stacked concentrically such that a convex surface of each of the Belleville springs operatively contacts a concave surface.

7. A two stage spring pack, comprising:
a back up insulator proximate the two stage spring pack;
a first stage spring for applying an initial force; and
a plurality of Belleville springs to exert a secondary force.

8. The two stage spring pack according to claim 7, wherein a spring retainer is contained within and slideably engages a spring retainer recess in a backing plate.

9. The two stage spring pack according to claim 7, wherein a cover plate surrounding the back up insulator prevents movement of a spring retainer as it preloads the Belleville springs.

10. The two stage spring pack according to claim 9, wherein a plurality of fasteners is used to secure the cover plate to a backing plate.

11. The two stage spring pack according to claim 10, wherein the plurality of fasteners are socket head cap screws.

12. The two stage spring pack according to claim 7, wherein the back up insulator comprises a back up insulator head at one end, a back up insulator shaft, located distally from the back up insulator head, and a back up insulator flange located there between.

13. The two stage spring pack according to claim 12, wherein the back up insulator shaft slideably engages a back up insulator bore in a backing plate.

14. The two stage spring pack according to claim 7, wherein the plurality of Belleville springs is contained within a spring bore in a backing plate.

15. A method for applying two dissimilar spring loads to hot runner components using a two stage spring pack to prevent resin leakage there between, comprising the steps of:
heating a cross manifold to induce its thermal expansion against a back up insulator;
compressing a first stage spring via a back up insulator flange;
preloading a plurality of Belleville springs via a spring retainer; and
deflecting the plurality of Belleville springs beyond their preloaded state to induce a secondary force on the cross manifold.

16. The method according to claim 15, further comprising the step of:
sealing a manifold melt channel interface between the cross manifold and a main manifold by stationing the two stage spring pack in a backing plate distally from a center insulator with both the cross manifold and the main manifold situated there between.

17. A two stage spring pack for use in a hot runner in an injection molding system, comprising:
a back up insulator which abuts a cross manifold;
a first stage spring located directly beneath a back up insulator flange for applying an initial preload to said cross manifold; and
a plurality of Belleville springs encircling a back up insulator shaft, to exert a secondary force on said cross manifold.

18. The two stage spring pack according to claim 17, wherein a plurality of first stage springs is implemented.

19. The two stage spring pack according to claim 17, wherein the back up insulator is made of lower thermally conductive material than that of the cross manifold.

20. The two stage spring pack according to claim 17, wherein a spring retainer contains and preloads the Belleville springs.

21. The two stage spring pack according to claim 17, wherein a cover plate surrounding the back up insulator prevents movement of a spring retainer as it preloads the Belleville springs.

22. The two stage spring pack according to claim 21, wherein a plurality of fasteners is used to secure the cover plate to a backing plate.

23. The two stage spring pack according to claim 17, wherein the back up insulator shaft slideably engages a back up insulator bore in a backing plate.

24. The two stage spring pack according to claim 17, wherein the plurality of Belleville springs is contained within a spring bore in a backing plate.

25. The two stage spring pack according to claim 17, wherein the Belleville springs are stacked together concentrically in a series or in a parallel configuration or a combination thereof.
